(19) United States
(12) Patent Application Publication
(10) Pub. No.: US 2023/0180796 A1
(43) Pub. Date: Jun. 15, 2023

(54) COMPOSITION FOR THE PREPARATION OF A BEVERAGE BASED ON OAT

(71) Applicants: Valérie Gott, Berlin (DE); Benjamin Binder, Berlin (DE)

(72) Inventors: Valérie Gott, Berlin (DE); Benjamin Binder, Berlin (DE)

(21) Appl. No.: 18/073,076

(22) Filed: Dec. 1, 2022

(30) Foreign Application Priority Data
Dec. 10, 2021 (LU) 102890

(51) Int. Cl. A23L 2/395; A23C 11/10; A23L 2/84; A23L 7/104; A23L 3/46; A23L 2/52

(52) U.S. Cl. CPC A23L 2/395; A23C 11/10; A23L 2/52; A23L 2/84; A23L 3/46; A23L 7/107; A23V 2002/00

(57) ABSTRACT

A manufacturing method for a plant-based water-soluble dry powder, comprising the steps of; preparing a first mixture by mixing water with oats; comminuting solid components in the first mixture; heating the first mixture to a temperature range between 60° - 70° C.; adding α- and/or β-amylases and incubating for at least 40 min at 60° - 70° C.; filtering the first mixture; adding liquid fat or oil to the first mixture in a ratio of 65 wt. - % of the first mixture and 35 wt% liquid fat or oil; and spray drying the mixture of first mixture and fat or oil.

### CROSS REFERENCE TO RELATED APPLICATIONS

The present application claims priority to Luxembourg Patent Application No. LU 102890 filed on December 10^{th}, 2021. The aforementioned application is hereby incorporated by reference in its entirety.

### BACKGROUND OF THE INVENTION

### Field of the Invention

The invention relates to a composition for the preparation of an oat milk product.

### Brief Description of the Related Art

In the course of a diet with plant-based foods, cow’s milk is replaced by beverages that contain plant extracts in addition to water. In most cases, soybeans or oat flakes are used as vegetable ingredients. Drinks based on oat flakes are then also referred to as “oat milk”, although strictly speaking this is not “milk”, as this designation is reserved for animal milks. In the trade, a cereal milk made from oats is therefore often referred to as an “oat drink”.

Devices for producing oat milk are known from the prior art. For example, DE 20 2012 103 875 U1 describes an oat milk production apparatus comprising a slurry unit and a pulp unit arranged below that slurry unit.

The published German patent application DE 10 2019 206 094 A1 relates to a soymilk maker comprising a filter for receiving soybeans, a drive, a crushing tool, and a jug. The filter is arranged in the jug and allows the crushing tool to be inserted into the filter. In a first step, the drive drives the crushing tool, crushing the soybeans with the crushing tool in the filter to produce soymilk and residual material from the soybeans. In a second step, the drive rotates the filter. After crushing the soybeans, the filter is rotated to separate the liquid soymilk from the remaining residual material by centrifugal force.

Chinese patent reference CN 106 721 789 B relates to an oat-linolenic acid composite beverage and a method for producing that beverage. The oat-linolenic acid composite beverage is mainly prepared from the following raw materials in mass percent: 1-6% oats, 1-8% linseed oil, 2-3% maltose, 0.2-0. 6% fructo-oligosaccharide, 1-3% xylitol, 1-4% cane sugar or starch syrup, 2-6% coconut milk, 0.1-0.3% of a composite emulsion stabilizer, 0.005-0.01% edible essence and 0.1-1% sodium mascorbate. In the oat-linolenic acid composite drink according to CN 106 721 789 B, the oat is used as the main raw material, the linseed oil and coconut milk are added, the specific composite emulsion stabilizer is adjusted, and a specific technology is used, so that the oat-linolenic acid composite drink is produced. The high content of omega-3 fatty acids in the oat beverage is ensured, and good stabilization effect can also be achieved. At normal temperature, the oat-fer-linolenic acid composite beverage does not form precipitates after standing for 3 months and is free of a stratification phenomenon and the phenomenon, that fat floats to the top. It is considered disadvantageous in terms of the present invention that the beverage according to CN 106 721 789 B contains a large number of ingredients and requires, among other things, emulsion stabilizers.

A beverage marketed under the name “Oatly” is known from the prior art. This is an oat milk beverage to which fat has been added. A disadvantage of this beverage is that dipotassium hydrogen phosphate is added to homogenize the multitude of ingredients.

Furthermore, a vanilla-flavored beverage powder marketed under the name “Preco Avena” is known. This is a powder, which can be stirred into cow’s milk to give it a vanilla flavor. The disadvantage of this product is that it is used with classic whole milk and therefore no vegan end product is created.

A beverage powder is marketed under the name “Natural Gristmill”, which uses powdered canola oil in addition to oats. Different powders are mixed to produce the beverage powder. Furthermore, ingredients for easier solubility are present and it is considered disadvantageous that the beverage powder does not consist of a homogeneous, well soluble powder, which is only based on oats and fatty oils, which are inseparably combined in one powder.

Published Chinese patent CN 104 855 790 B discloses an oat electrolate and a manufacturing method. This document relates to an oat electrolate that is not mixed with hot water, can be consumed directly, can be combined with fruit juice and vegetable juice, has high nutritional value and good taste, and can be easily absorbed by the human body, and a corresponding manufacturing method. Oatmeal milk consists of the following raw materials (in parts by weight): 70-90 parts oatmeal, 1-3 parts soy isolate proteins, 5-20 parts maltodextrin, 0.1-0.3 parts anhydrous dipotassium hydrogen phosphate, 0.05-0.2 parts sucrose ester, 0.1-0.4 parts monostearin, and 5-10 parts natural vegetable oil. The oat electrolate can be eaten immediately, is rich in nutrients and easy to digest, and moreover, the oat electrolate is used as a new kind of food raw material in food products such as solid drinks and the like. The disadvantages of the product are the large number of ingredients and the use of the emulsifier dipotassium hydrogen phosphate. Furthermore, the complex manufacturing process with a large number of steps using enzymes and spray drying at high temperatures results in a granulate and not in a powder.

The plant-based beverages used to replace cow’s milk consist predominantly of water. The transport of the beverages therefore mainly involves the transport of water, which can be regarded as disadvantageous in terms of sustainability, since water is available everywhere locally in excellent quality, at least in the northern hemisphere, especially in Europe.

From the prior art cited above, known beverages or powders mostly have a variety of ingredients, including dipotassium hydrogen phosphate to homogenize the dissolved ingredients.

Thus, there is a need for a composition from which a vegetable beverage can be prepared solely by the addition of water.

### SUMMARY OF THE INVENTION

The technical problem according to the disclosure is solved by the features of the independent claims. Further embodiments are given in the dependent claims.

The present disclosure provides a manufacturing method for a water-soluble dry powder, comprising the steps of;
a. Preparing a first mixture by mixing water with oats in a ratio of 50-65 wt% water with 35-50 wt% oats to then 100 wt% of the first mixture;
b. Comminuting solid ingredients in the first mixture;
c. Heating the first mixture to a temperature ranging between 60° - 70° C.;
d. Addition of α- and/or β-amylases and incubation for at least 40 min at 60° - 70° C.;
e. Filtering of the first mixture;
f. Adding liquid fat or oil to the first mixture in a ratio of 65 wt% of the first mixture and 35 wt% liquid fat or oil to obtain 100 wt% of a second mixture; and
g. Spray drying the second mixture to obtain a homogeneous powder.

In one embodiment, spray drying may be carried out in a temperature range from 65° C. to 68° C.

It is provided according to the invention that the spray drying takes place at 67.5° C.

In a further embodiment of the invention, the spray drying takes place in a spray tower.

Furthermore, it may be provided that the powder is over sprayed with lecithin after spray drying.

In another aspect of the invention, it is possible that phosphates are added prior to spray drying.

The method according to the invention may further comprise the step of adding vitamins prior to spray drying.

Another object of the present invention relates to a method of using a dry powder for the preparation of a beverage comprising the steps of preparing a first mixture by mixing water with oats in a ratio of 50-65 wt% water with 35-50 wt% oats to then 100 wt% of the first mixture; comminuting solid ingredients in the first mixture; heating the first mixture to a temperature ranging between 60° - 70° C.; addition of α- and/or β-amylases and incubation for at least 40 min at 60° - 70° C.; filtering of the first mixture; adding liquid fat or oil to the first mixture in a ratio of 65 wt% of the first mixture and 35 wt% liquid fat or oil to obtain 100 wt% of a second mixture; spray drying the second mixture to obtain a homogeneous powder; and mixing the spray dried second mixture with water.

The method for preparing of a beverage may further comprise the mixing of the dried second mixture with water in a ratio of 1:10, such that each gram of the dried second mixture is mixed with 10 ml of water.

Further, the invention relates to a vegetable-based beverage having a fat content of 3-4 wt%, prepared by mixing a dry powder from the process previously described with water.

### BRIEF DESCRIPTION OF THE FIGURES

The invention is described in more detail below with reference to figures. It will be obvious to those skilled in the art that this is only one possible embodiment, without limiting the invention to the embodiments shown. It shows:

FIG. 1 schematically illustrates the process for the production of a dry powder

FIGS. 2A and 2B show comparative results of tests on the solubility of beverage powders.

FIG. 3 shows comparative results of experiments on the foamability of solutions of beverage powders.

### DETAILED DESCRIPTION OF THE INVENTION

The present invention provides a rapidly dissolvable, fat-containing, readily foamable, and purely plant-based milk surrogate and a method for its preparation.

Oats in the sense of the present invention are understood to be oat flakes, the whole grain or milled oats.

The milk surrogate according to the present invention is accumulated as a homogeneous powder obtained by spray drying. It may be considered particularly advantageous for preparing a vegetable beverage by adding water that this homogeneous powder contains fat, which is inseparable from the other components. On the one hand, the dissolved powder can serve as an energy supplier and is also important as a flavor carrier. Animal milk is an emulsion of fat and water containing emulsifiers. Therefore, it is desirable that a vegetable milk, which serves as a substitute for animal milk, also contains fat, but preferably without any other ingredients.

Furthermore, it is of importance that the powder dissolves easily and quickly in water, so that a vegetable drink is obtained as a product, which is also equivalent to animal milk regarding a wholesome diet.

All percentages in the present disclosure refer to mass and are thus to be understood as percentages by weight.

The dry powder according to the present invention is obtained by a process comprising the following steps: Initially, oats are mixed with water. For this purpose, rolled oats, whole oats and/or milled oats are soaked in water. The solid components of this mixture are then crushed. The mixture is heated to a temperature ranging between 60° C. to 70° C. and α- and/or β-amylases are then added. The mixture is allowed to stand for at least 40 min for enzymatic reaction and then filtered to remove solids from that mixture. For the filtering process, the screen size is selected in a manner, that it is not too small, and the filter does not get clogged. For example, single-layer cotton cloths are suitable.

In the next step, 35% by weight of liquid fat or oil is now added to 65% by weight of the oat mass. This means that to 1,000 g of the oat mass, a total of 126 g of liquid fat or oil is added. Subsequent spray drying the mixture of oat mass and oil results in a powder. Mixing this powder with water in a ratio of 1:10, this ratio of oat mass and oil results in a vegetable beverage that has a fat content of 3.8% by weight, which corresponds to the fat content of commercially available whole milk.

The mixture of oat mass with liquid fat or oil is reduced to its dry mass on a spray tower. Spray drying is carried out at a temperature in the range of 65° C. - 68° C., particularly preferably at 67.5° C. This temperature range has proven to be particularly advantageous, since starch is broken down, but protein compounds are not dissolved.

Homogenization is achieved by spray drying, which advantageously prevents the formation of fat deposits when the dry powder is later dissolved in water. The enrichment of the oat mass with fat and the subsequent spray drying have diverse advantages: On the one hand, the fat as a flavor carrier gives this milk surrogate a more pleasant taste. On the other hand, some further processing possibilities of animal-milk or its alternatives require the presence of fat.

Spray drying encapsulates the fat, which significantly extends the shelf life of the powder. A homogeneous powder is obtained as a product of the spray drying according to the present process, which can be easily dissolved. To improve cold solubility in particular and thus increase convenience, lecithin can optionally be added to or sprayed over the powder after drying. This natural emulsifier stores nitrogen between the particles, resulting in a highly soluble powder, which, in the dissolved state, has all the qualities of a conventional vegetable drink. According to the invention, lecithin from sunflowers is preferred, as this avoids incompatibilities with lecithin from soy, which can have allergenic residues. Moreover, the use of lecithin from sunflowers is considered more sustainable.

From the prior art, only complex processes for the production of purely vegetable-based dry powders by a lengthy homogenization process are known, so that an oil or fat combines with other ingredients. The present manufacturing process is based on the surprising realization that the process can be significantly simplified if the specific sequence of steps is as claimed.

It was surprising to find that spray drying under the specified conditions results in a homogeneous - and above all - readily soluble powder, in which the constituent parts of an aqueous oat mixture are combined with only liquid fat or oil. This homogeneous powder exhibits significantly better dissolving properties compared to an oat beverage powder prepared by roll-drying the aqueous oat mixture with liquid fat or oil.

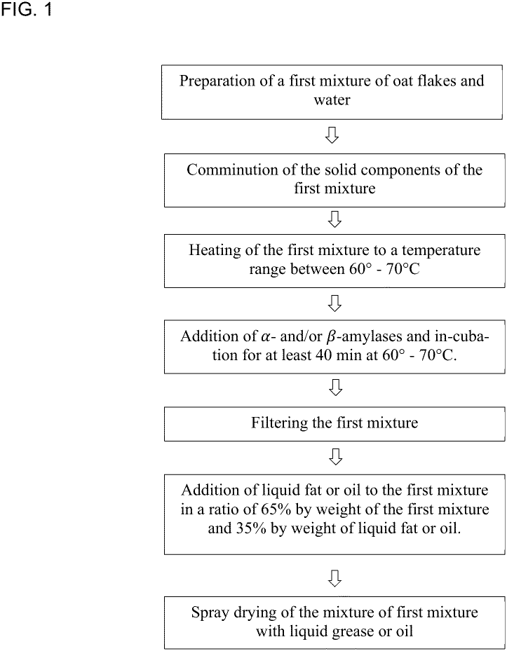

FIG. 1 schematically illustrates the process flow according to the present invention.

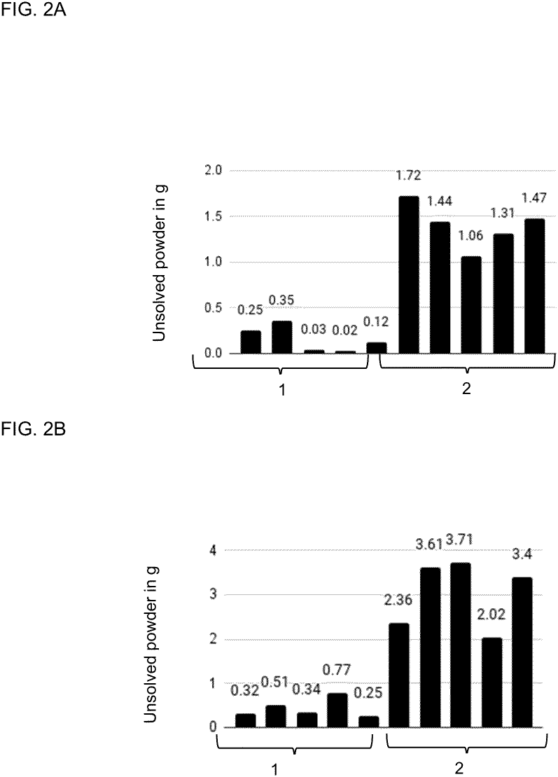

FIG. 2A and FIG. 2B show the results of solution tests. In each case, 20 g of powder was added to 200 ml of water. In FIG. 2A, the mixtures were shaken for 10 seconds and FIG. 2B for 20 seconds. The liquid was then removed and the mass of undissolved powder in each case was determined. Five experiments were performed for each of the two times of shaking. By 1 is denoted a powder according to the present invention, and by 2 is denoted an oat milk beverage powder in which the mixture of aqueous oat solution with liquid fat or oil was dried in a roller-dryer.

FIG. 2A and FIG. 2B clearly show the considerably better solubility of a dry powder according to the present invention. These results are surprising because spray drying has previously only been used with cow’s milk, i.e., emulsified fat in an aqueous solution. It is considered surprising that spray drying can also be used to produce a homogeneous powder that is much more soluble in water with no emulsifiers or other ingredients present, thus only water, oats, and liquid fat or oil being the sole ingredients.

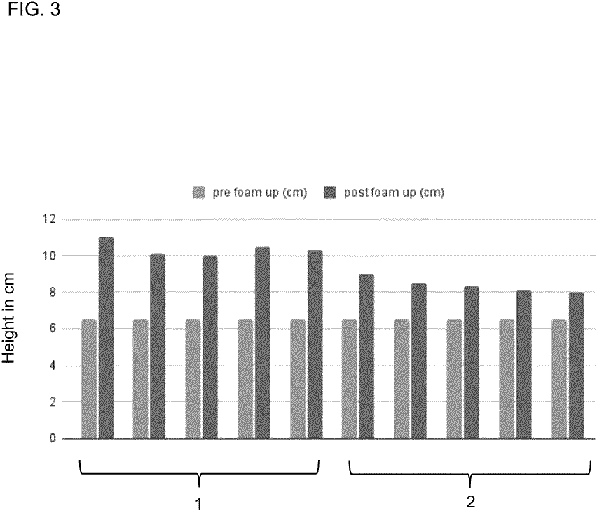

In addition to better solubility, the powder dissolved in water according to the present invention also results in better foaming of the resulting beverage. FIG. 3 shows the results of a series of experiments with five repetitions each for foaming a beverage. On the one hand, a dry powder according to the present invention was dissolved in water at a ratio of 1 part of powder to 10 parts of water (denoted 1). Further, an oat milk beverage powder prepared using the roller drying process. was dissolved in water at a ratio of 1 part of powder to 10 parts of water (denoted 2). The height of the liquid in the cup of the milk frother was measured before frothing. The resulting solutions were heated identically to about 65° C. in a milk frother with a stirring device located on its bottom. They were frothed by the stirring device for the same time. Subsequently, the height of the liquid with foam on top was measured.

It can be seen from FIG. 3 that with identical initial heights of the solutions, the beverage based on the dry powder according to the present invention reaches a height of at least 10 cm in each case. In contrast, a beverage based on roller drying reaches a maximum height with foam of 9 cm. Surprisingly, the spray drying according to the present invention leads to a significantly better foaming of a purely vegetable beverage made from the starting materials water, oats and liquid oil or fat. This is advantageous when an oat milk made from a dry powder according to the present invention is used for the production of any kind of vegan milk foam drink.

The present invention thus overcomes a known problem in the production of a purely vegetable-based beverage powder. In addition to improved solubility of the dry powder, the solution itself also has advantageous properties, such as improved foamability.

It is intended to deliver the dry powder resulting from the spray drying in 100 g portions, which is then mixed with 11 of water to obtain a vegetable-based beverage having the fat content of whole milk.

What is claimed is:

1. A method for manufacturing a water-soluble dry powder, comprising the steps of;
a. preparing a first mixture by mixing water with oats in a ratio of 50-65 wt% water with 35-50 wt% oats to then 100 wt% of the first mixture;
b. comminuting solid ingredients in the first mixture;
c. heating the first mixture to a temperature ranging between 60° - 70° C.;
d. addition of α- and/or β-amylases and incubation for at least 40 min at 60° - 70° C.;
e. filtering of the first mixture;
f. adding liquid fat or oil to the first mixture in a ratio of 65 wt% of the first mixture and 35 wt% liquid fat or oil to obtain 100 wt% of a second mixture; and
g. spray drying the second mixture to obtain a homogeneous powder.

2. The method of claim 1, wherein the spray drying is carried out in a temperature range from 65° C. to 68° C.

3. The method of claim 1, wherein the spray drying takes place at 67.5° C.

4. The method of claim 1, wherein the spray drying takes place in a spray tower.

5. The method of claim 1, comprising the step of over spraying the powder with lecithin after spray drying of the second mixture.

6. The method of claim 1, comprising the step of adding phosphates are added prior to spray drying.

7. The method of claim 1 further comprising the step of adding vitamins prior to spray drying.

8. A method of using a dry powder for the preparation of a beverage comprising the steps of:
a. preparing a first mixture by mixing water with oats in a ratio of 50-65 wt% water with 35-50 wt% oats to then 100 wt% of the first mixture;
b. comminuting solid ingredients in the first mixture;
c. heating the first mixture to a temperature ranging between 60° - 70° C.;
d. addition of α- and/or β-amylases and incubation for at least 40 min at 60° - 70° C.;
e. filtering of the first mixture;
f. adding liquid fat or oil to the first mixture in a ratio of 65 wt% of the first mixture and 35 wt% liquid fat or oil to obtain 100 wt% of a second mixture;
g. spray drying the second mixture to obtain a homogeneous powder; and
h. mixing the spray dried second mixture with water.

9. The method of claim 8, wherein the mixing is done in a ratio of 1:10, such that each gram of the dried second mixture is mixed with 10 ml of water.

10. A vegetable-based beverage having a fat content of 3 - 4 wt%, prepared by mixing a dried second mixture according to claim 1 with water.
